(19) United States
(12) Patent Application Publication
(10) Pub. No.: US 2015/0266025 A1
(43) Pub. Date: Sep. 24, 2015

(54) LIQUID FEED DEVICE AND VALVE SYSTEM

(71) Applicant: Kabushiki Kaisha Toshiba, Minato-ku (JP)

(72) Inventors: Shinya TANIKAWA, Arakawa (JP); Kenichi ARAME, Fukushima (JP); Masayuki YUMOTO, Kawasaki (JP); Hirotaka UNNO, Ota (JP); Tetsuya KUWABARA, Kawasaki (JP); Jun OKADA, Setagaya (JP)

(73) Assignee: Kabushiki Kaisha Toshiba, Minato-ku (JP)

(21) Appl. No.: 14/626,205

(22) Filed: Feb. 19, 2015

(30) Foreign Application Priority Data
Mar. 20, 2014 (JP) 2014-057882

(51) Int. Cl. B01L 3/00

(52) U.S. Cl. CPC B01L 3/567; B01L 2300/123; B01L 2200/06; B01L 2400/065

(57) ABSTRACT

According to one embodiment, a liquid feed device includes a support substrate and an intermediate member. The intermediate member is provided on the support substrate. A valve and a flow channel of fluid are formed by the intermediate member. The valve communicates with the flow channel. The valve includes an outer edge portion and a gap. The gap is provided between the outer edge portion and the support substrate. The valve is capable of opening and closing the gap by the outer edge portion being pressed and released. A configuration of the outer edge portion when projected onto a plane perpendicular to a direction of the flow channel is a protruding configuration having a curved surface. The configuration of the outer edge portion is symmetric with respect to the direction of the flow channel.

### CROSS-REFERENCE TO RELATED APPLICATIONS

This application is based upon and claims the benefit of priority from Japanese Patent Application No. 2014-057882, filed on Mar. 20, 2014; the entire contents of which are incorporated herein by reference.

### FIELD

Embodiments described herein relate generally to a liquid feed device and a valve system.

### BACKGROUND

In the field of medicine, there is a testing device that feeds a reagent for analysis and tests the reagent. The testing device includes a liquid feed device and a pressing device that presses the liquid feed device.

The liquid feed device includes a holder that holds the reagent and a reactor that causes the reagent to react. The holder and the reactor communicate with each other by a fine flow channel. The amount of the reagent flowing in the flow channel is controlled by a valve being opened and closed by the pressing device. It is desirable to downsize the entire device while maintaining the performance of the device.

### BRIEF DESCRIPTION OF THE DRAWINGS

FIG. 1A is a schematic view showing a liquid feed device according to a first embodiment and shows a decomposed perspective view of the liquid feed device;

FIG. 1B is a schematic view showing the liquid feed device according to the first embodiment and shows a plan view of the liquid feed device;

FIG. 2A is an enlarged schematic view showing main parts in a valve system for the liquid feed device according to the first embodiment and shows a front view of the valve system;

FIG. 2B is an enlarged schematic view showing the main parts in the valve system for the liquid feed device according to the first embodiment and shows an enlarged view of the main parts of a cross section along plane A-A of FIG. 2A;

FIG. 2C is an enlarged schematic view showing the main parts in the valve system for the liquid feed device according to the first embodiment and shows an exterior view of a valve;

FIG. 2D is an enlarged schematic view showing the main parts in the valve system for the liquid feed device according to the first embodiment and shows an exterior view of the valve;

FIG. 2E is an enlarged schematic view showing the main parts in the valve system for the liquid feed device according to the first embodiment and shows a cross sectional view of the valve along plane B-B of FIG. 2A;

FIG. 3A to FIG. 3E are schematic views showing portions of different valve systems and show cross sections of valves when changing configuration and thickness of each valve;

FIG. 4 is a table showing a relationship between the structures of the valves and the closure loads inside the valve systems;

FIG. 5A to FIG. 5E are schematic views showing portions of different valve systems and show cross sections of valves when changing configuration and thickness of each valve;

FIG. 6 is a table showing a relationship between the structures of the valves and the closure loads inside the valve systems;

FIG. 7A is a cross sectional view schematically showing a portion of the valve system in the state that the valve is closed;

FIG. 7B is an enlarged view of region P3 of FIG. 7A.

FIG. 8 is a schematic cross sectional view showing an enlarged valve in a valve system for a liquid feed device according to a second embodiment;

FIG. 9A and FIG. 9B show schematic cross sectional views showing the state that the valve contacts a punch according to the second embodiment;

FIG. 10 is a table showing a relationship between the structures of the valves and the closure loads inside the valve systems;

FIG. 11 is a graph showing a relationship between the load inside the valve system and the displacement of the valve; and

FIG. 12 is a graph showing a relationship between the load inside the valve system and the displacement of the valve.

### DETAILED DESCRIPTION

According to one embodiment, a liquid feed device includes a support substrate and an intermediate member. The intermediate member is provided on the support substrate. A valve and a flow channel of fluid are formed by the intermediate member. The valve communicates with the flow channel. The valve includes an outer edge portion and a gap. The gap is provided between the outer edge portion and the support substrate. The valve is capable of opening and closing the gap by the outer edge portion being pressed and released. A configuration of the outer edge portion when projected onto a plane perpendicular to a direction of the flow channel is a protruding configuration having a curved surface. The configuration of the outer edge portion is symmetric with respect to the direction of the flow channel.

Embodiments of the invention will now be described with reference to the drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

### First Embodiment

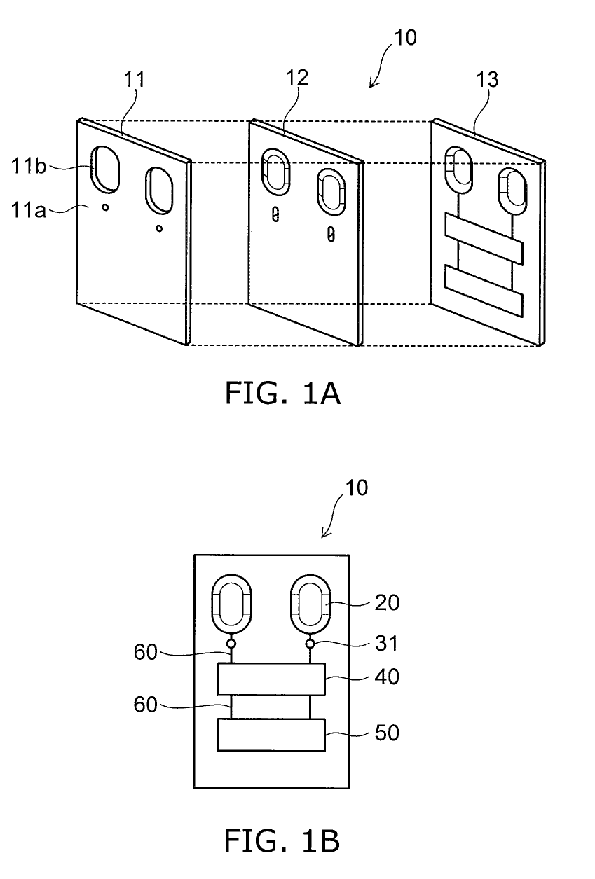

FIG. 1A and FIG. 1B are schematic decomposed perspective and plan views of a liquid feed device according to a first embodiment.

As shown in FIG. 1A, the liquid feed device (a liquid feed part) 10 is formed of an upper plate 11 having a rectangular configuration and corresponding to a cover, packing (an intermediate member) 12 having a rectangular configuration, and a lower plate (a support substrate) 13 having a rectangular configuration. For example, the liquid feed device 10 is assembled using the upper plate 11, the packing 12, and the lower plate 13. The liquid feed device 10 has, for example, a three-layer structure. The packing 12 is disposed between the upper plate 11 and the lower plate 13.

As shown in FIG. 1B, a syringe 20 corresponding to a holder of liquid, a valve 31, a first reactor 40, and a second reactor 50 are provided inside the liquid feed device 10. The syringe 20, the valve 31, the first reactor 40, and the second reactor 50 are connected to each other by a flow channel 60 inside the liquid feed device 10. A fluid such as a reagent or the like flows through the flow channel.

The liquid feed device 10 is, for example, a device used for DNA testing. The liquid feed device 10 is a DNA testing device in the description hereinbelow.

The upper plate 11 has a major surface 11a. A cap may be provided to cover at least a portion of the major surface 11a of the upper plate 11. For example, the cap has a rectangular configuration. For example, the cap is provided on the upper plate 11 to cover the upper surface portion of the major surface 11a. The upper plate 11 and the lower plate 13 are fixed by end portions of the cap. The packing 12 is fixed when the upper plate 11 and the lower plate 13 are fixed by the cap. Screws, etc., may be used when fixing the upper plate 11 and the lower plate 13 with the cap.

The upper plate 11 includes a resin, etc. The upper plate 11 has multiple openings 11b. A portion of the packing 12 is exposed from the openings 11b. For example, the syringe 20 and the valve 31 as shown by FIG. 1A are provided at the portions exposed at the openings 11b. A portion of a flow channel 60 in which a fluid such as a reagent or the like flows is provided in the valve 31.

The packing 12 includes a deformable elastic member. The packing 12 includes an elastic member having a loss coefficient of 0.1 or less at room temperature. It is desirable for the loss coefficient to be 0.1 or less so that the configuration returns to its original configuration from a state in which high pressure is applied for a long period of time. The packing 12 is an elastic body. In the embodiment, the packing 12 includes silicone rubber, etc. It is desirable to use a material having high reagent resistance to the packing 12. A portion of the packing 12 exposed at the opening 11b of the upper plate 11 is pressed by a punch (a pressing body) described below. The configuration of the packing 12 is deformed by the punch pressing the packing 12. A portion of the flow channel 60 is provided in the packing 12. The sealability of the flow channel is maintained by the packing 12 being provided in the liquid feed device 10.

The lower plate 13 includes a resin, etc. A portion of the flow channel is provided in the lower plate 13.

The syringe 20 has, for example, a region that contains and holds a reagent, etc. The region that contains and holds the reagent, etc., is defined by, for example, the packing 12 and the lower plate 13.

The syringe 20 has one or multiple holding regions.

The first reactor 40 and the second reactor 50 are regions where the reagent is caused to react.

The valve 31 is formed of the packing 12 and the lower plate 13. The flow rate of the fluid inside the valve 31 is controlled by the packing 12 being pressed by the punch.

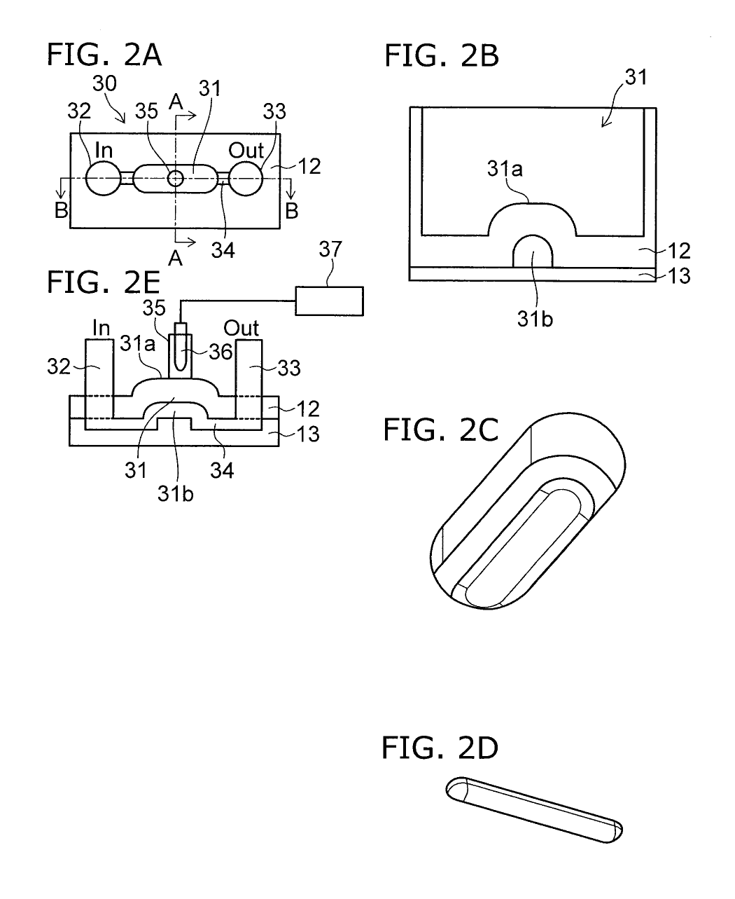

FIG. 2A to FIG. 2D are schematic views showing an enlarged valve system for the liquid feed device according to the first embodiment.

FIG. 2A is a front view showing a valve system 30. FIG. 2B is an enlarged view of main parts of a cross section along plane A-A of FIG. 2A. FIG. 2C and FIG. 2D are enlarged views of the exterior of the valve 31. FIG. 2E shows a cross sectional view along plane B-B of FIG. 2A.

As shown in FIG. 2A and FIG. 2E, the valve system 30 is constructed by a portion of the lower plate 13 and a portion of the packing 12 as shown by FIG. 1B, and, the valve system 30 is constructed by the valve 31, an input port 32, an output port 33, a micro flow channel 34, a pressure control port 35, a punch 36, and a pressure controller 37.

The valve 31 is formed by a portion of the packing 12 and has a major surface (an outer edge portion) 31a. The major surface 31a can contact the punch 36.

The valve 31 has a gap 31b provided between the packing 12 (the major surface 31a) and the lower plate 13. For example, the gap 31b is a region for adjusting the flow and controlling the flow rate of a fluid such as a reagent, etc. The gap 31b is a gap that passes and blocks the fluid.

In the valve system 30, the gap 31b of the valve 31 is opened and closed by contact between the major surface 31a and the punch 36 and by the punch 36 pressing the major surface 31a. The fluid is passed and blocked by the opening and closing of the gap 31b. Normally, the gap 31b is open.

The input port 32 and the output port 33 are, for example, two access ports inside the liquid feed device 10. The valve system 30 has no designated flow direction for fluid. For convenience of description, the ports positioned at the left side and the right side of FIG. 2A are taken to be the input port 32 and the output port 33, respectively.

The micro flow channel 34 is a flow channel formed by micromachining of a flow channel inside the liquid feed device 10 and is provided between the lower plate 13 and the packing 12. The fluid such as the reagent or the like flows in the micro flow channel 34. The micro flow channel 34 is connected to the gap 31b (of the valve 31) from the input port 32 and the output port 33. The micro flow channel 34 communicates with the valve 31.

The pressure control port 35 is erected and fixed on the valve 31. The punch 36 moves downwardly in the pressure control port 35 so that the punch 36 presses the valve 31.

The punch 36 includes an electromagnetic translatory actuator. For example, the maximum load when pressing is 2 kgf or less, and favorably 1 kgf or less.

The pressure controller 37 controls the pressure of the valve 31 by driving the punch 36 to be moved downwardly.

The pressure controller 37 can be provided at the exterior of the liquid feed device 10.

The pressure is supplied to the valve 31 by the driving of the punch 36 so that the configuration of the valve 31 is deformed. The gap 31b opens and closes to pass and block the fluid by deforming the configuration of the valve 31. The valve system 30 blocks the fluid when the load of the punch 36 on the valve 31 exceeds a constant value. The load at which the gap 31b is closed and the fluid is blocked is referred to as the closure load.

The valve 31 has a circular configuration (including a circular configuration and an elliptical configuration) when viewed in plan. In the embodiment, the configuration of the valve 31 is an elliptical configuration. The valve 31 has a circular configuration when projected onto a plane perpendicular to the direction from the lower plate 13 toward the packing 12.

As shown in FIG. 2B, the major surface 31a of the valve 31 has a semicircular configuration (including a semicircular configuration and a semielliptical configuration) when viewed in cross-section. For example, the configuration of the major surface (the outer edge portion) 31a when projected onto the plane perpendicular to the direction of the flow channel is a protruding configuration having a curved surface of a semicircular configuration, and the configuration of the major surface 31a is symmetric with respect to the direction of the flow channel. The major surface 31a is set to provide a closure load of 2 kgf or less, and favorably 1 kgf or less; and the major surface 31a has a configuration such that the packing 12 does not damage when closing.

Also, the gap 31b of the valve 31 has a semicircular configuration when viewed in cross-section. The gap 31b has a semicircular configuration when projected onto the plane perpendicular to the direction of the flow channel. In FIG. 2B, a portion of the packing 12 surrounding the valve 31 protrudes upwardly. This means that the valve 31 is formed at a portion recessed from a surface of the packing 12 as shown by FIG. 1A.

As described above, the configuration of the major surface (the outer edge portion) 31a when projected onto the plane perpendicular to the direction of the flow channel is a protruding configuration having a curved surface, and the configuration of the major surface 31a is symmetric with respect to the direction of the flow channel. In such a case, for example, the configuration of the major surface (the outer edge portion) 31a has line symmetry with respect to a straight line passing through the center of the gap 31b.

In the case where the gap 31b has the semicircular configuration when viewed in cross-section, the center of the gap 31b corresponds to the center of a circular. In the case where the gap 31b has a polygonal configuration when viewed in cross-section, for example, the center of the gap 31b corresponds to a crossing point of lines extending from vertexes to the opposite sides.

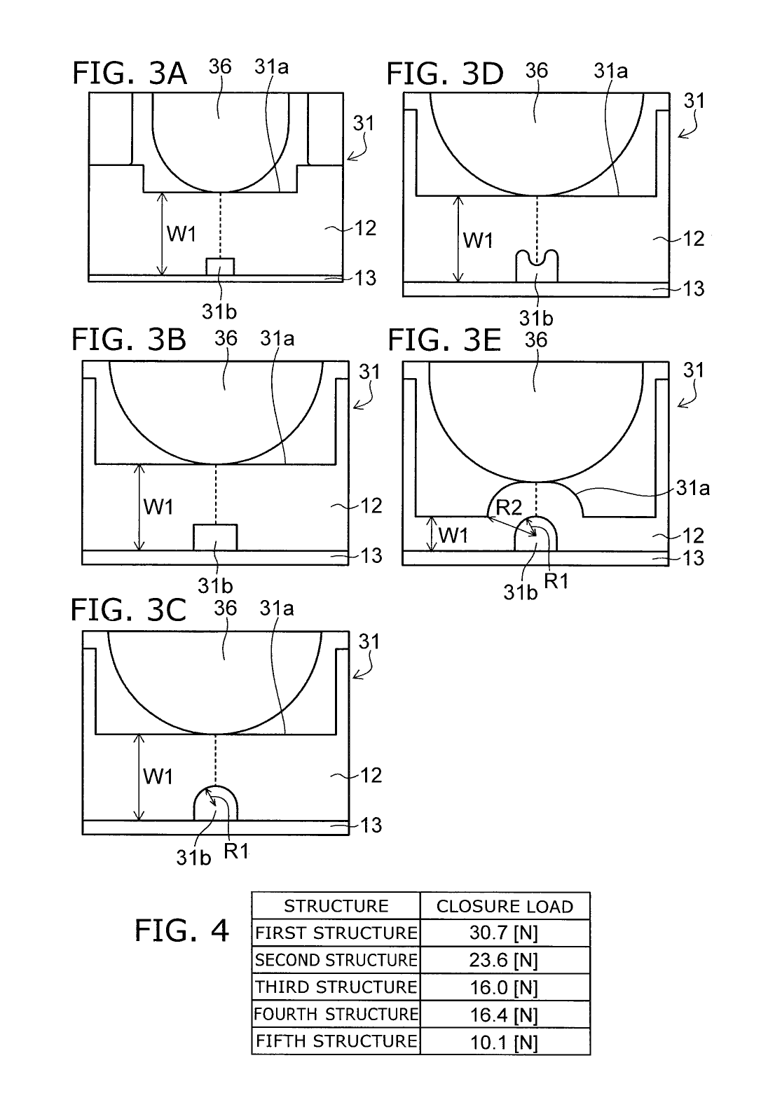

The straight line passing through the center of the gap 31b corresponds to a straight line extending from the center of the gap 31b in a direction perpendicular to a bottom surface of the lower plate 13. For example, the straight line passing through the center of the gap 31b corresponds to a straight line from the center of the gap 31b to the packing 12 in the perpendicular direction, as dotted lines shown in FIG. 3A to FIG. 3E.

As shown in FIG. 2C and FIG. 2D, the valve 31 has a circular configuration when viewed in plan and is a tube-type valve having a semicircular configuration when viewed in cross-section. FIG. 2C is an exterior view (perspective view) of the valve 31 as viewed from the major surface 31a side. FIG. 2D is an exterior view of the gap 31b of the valve 31 as viewed from the side opposite to the major surface 31a.

As described above, in the embodiment, the configuration of the major surface 31a of the valve 31 when viewed in cross-section is set to be a semicircular configuration; the configuration of the gap 31b of the valve 31 when viewed in cross-section is set to be a semicircular configuration; and the valve 31 is formed to be a tube-type valve. Therefore, the closure load of the punch 36 on the valve 31 is reduced.

Two-dimensional analysis results used as a basis for discovering the configuration of the valve 31 such as those recited above will now be described.

### First Analysis

FIG. 3A to FIG. 3E are views showing portions of different valve systems.

FIG. 4 is a table showing the closure loads inside the different valve systems.

FIG. 3A to FIG. 3E are cross-sectional views of valves having different configurations. More specifically, the cross sections of valves having different configurations are shown for different configurations of the major surface 31a of the valve 31, configurations of the gap 31b of the valve 31, and thicknesses W1 of the valve 31, as shown by FIG. 2B. In the drawings, the dotted line indicates that the center of the punch 36 matches the center of the gap 31b.

FIG. 4 shows the closure load (N) of the punch 36 applied to each valve at the structures of FIG. 3A to FIG. 3E.

An example of FIG. 3A corresponds to a valve that the configuration of the major surface 31a of the valve 31 shown by FIG. 2A to FIG. 2E is set to be a straight line configuration when viewed in cross-section; and the configuration of the gap 31b of the valve 31 is set to be a quadrilateral configuration when viewed in cross-section. The thickness W1 of the valve 31 is 1.5 millimeters. The structure of FIG. 3A is referred to as a first structure.

An example of FIG. 3B corresponds to a valve that the configuration of the major surface 31a of the valve 31 is set to be a straight line configuration when viewed in cross-section; and the configuration of the gap 31b of the valve 31 is set to be a quadrilateral configuration when viewed in cross-section. The thickness W1 of the valve 31 is 1.0 millimeters. The valve 31 of FIG. 3B is a valve in which the thickness W1 of the valve 31 shown in FIG. 3A has been changed. The structure of FIG. 3B is referred to as a second structure.

An example of FIG. 3C corresponds to a valve that the configuration of the major surface 31a of the valve 31 is set to be a straight line configuration when viewed in cross-section; and the configuration of the gap 31b of the valve 31 is set to be a semicircular configuration when viewed in cross-section. The thickness W1 of the valve 31 is 1.0 millimeters. A radius R1 of the circle of the gap 31b is 0.25 millimeters. The structure of FIG. 3C is referred to as a third structure.

An example of FIG. 3D corresponds to a valve that the configuration of the major surface 31a of the valve 31 is set to be a straight line configuration when viewed in cross-section; and the configuration of the gap 31b of the valve 31 is set to be a recessed configuration (a wavy configuration) when viewed in cross-section. The thickness W1 of the valve 31 is 1.0 millimeters. The structure of FIG. 3D is referred to as a fourth structure.

An example of FIG. 3E corresponds to a valve that the configuration of the major surface 31a of the valve 31 is set to be a semicircular configuration when viewed in cross-section; and the configuration of the gap 31b of the valve 31 is set to be a semicircular configuration when viewed in cross-section. The thickness W1 of the valve 31 is 0.4 millimeters. The radius R1 of the circle of the gap 31b is 0.25 millimeters. A radius R2 of the circle of the major surface 31a is 0.4 millimeters. The structure of FIG. 3E is referred to as a fifth structure. The structure of the valve 31 of the embodiment corresponds to the fifth structure.

Among the first to fifth structures as shown in FIG. 4, the closure load of the fifth structure is smallest. It was found that the tube-type valve 31 of the embodiment is effective for reducing the closure load.

### Second Analysis

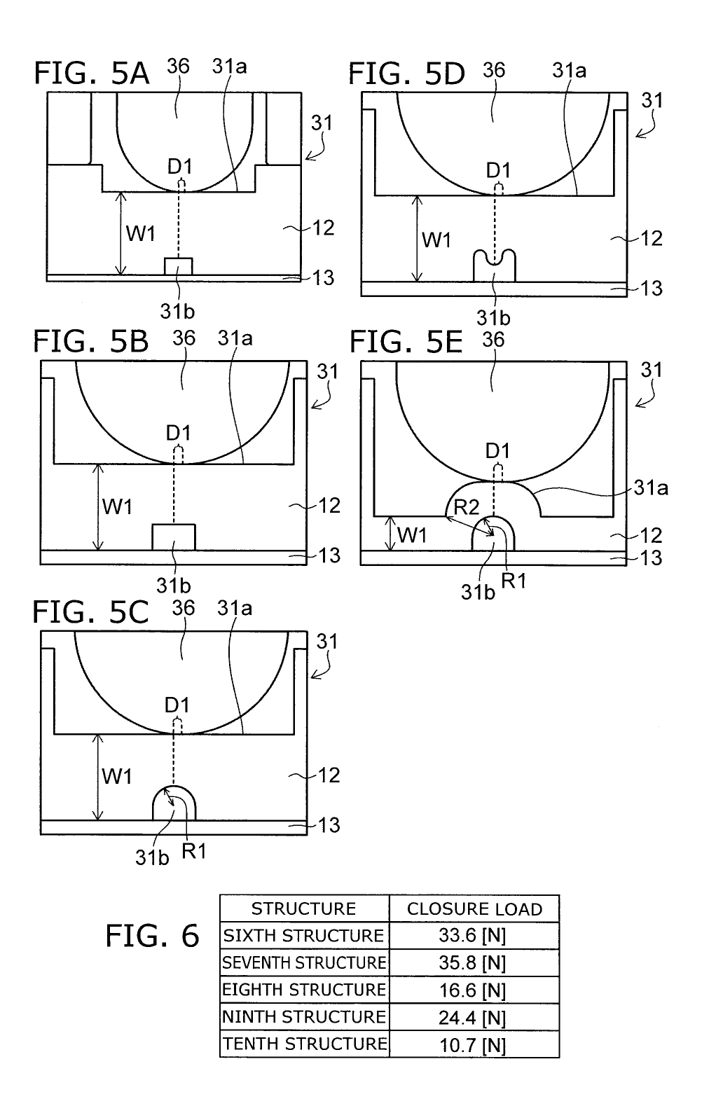

FIG. 5A to FIG. 5E are views showing portions of different valve systems.

FIG. 6 is a table showing the closure loads inside the different valve systems.

FIG. 5A to FIG. 5E are views showing cross sectional structures in which the center of the punch 36 is shifted D1 to the right from the center of the gap 31b of the structures of FIGS. 3A to 3E. In the analysis, D1 is 0.1 millimeters. Otherwise, the constructions of the analysis are the same as those of the first analysis. The structures of FIG. 5A to FIG. 5E are referred to as sixth to tenth structures.

FIG. 6 shows the closure load (N) of the punch 36 applied to each valve at the structures of FIG. 5A to FIG. 5E.

Among the sixth to tenth structures as shown in FIG. 6, the closure load of the tenth structure is smallest. In the case where the center of the punch 36 is shifted D1 to the right from the center of the gap 31b, the effects on the closure load (N) of the punch 36 are small. It was found that the tube-type valve of the embodiment is effective for reducing the closure load.

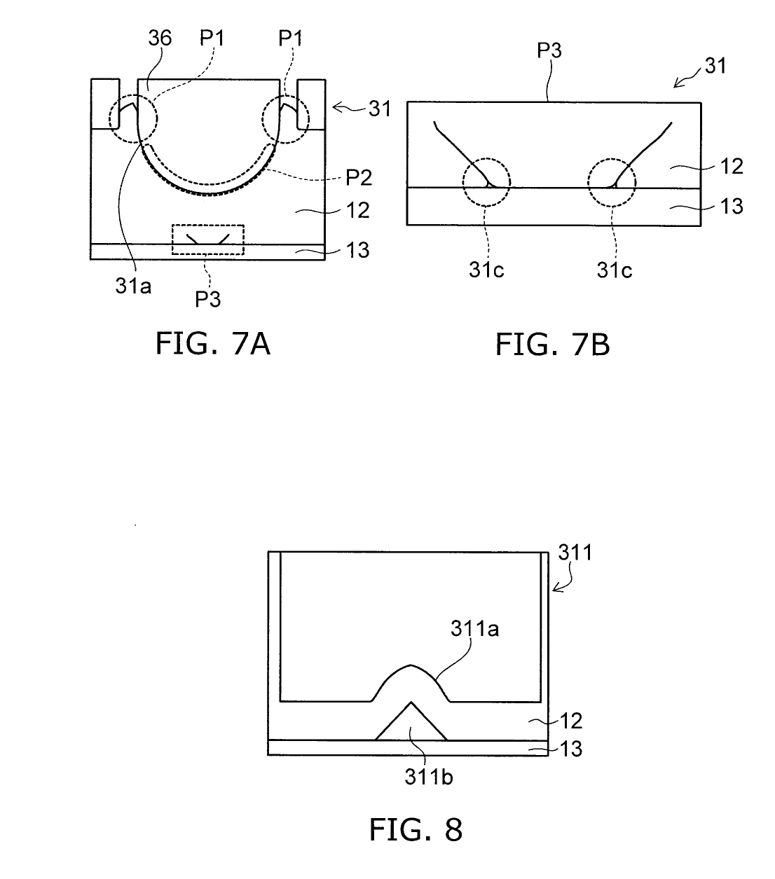

FIG. 7A and FIG. 7B show a portion of the valve system.

FIG. 7A shows the state in which the valve 31 is closed by the load of the punch 36 in a valve system having the first structure of FIG. 3A. FIG. 7B is an enlarged view of region P3 shown in FIG. 7A.

As described above, in the valve system having the first structure of FIG. 3A, the configuration of the major surface 31a of the valve 31 has a straight line configuration when viewed in cross-section. As shown in region P1 of FIG. 7A, the likelihood of the punch 36 grabbing the packing 12 when the valve 31 is closed is high. Because the punch 36 grabs the packing 12, the contact surface area between the packing 12 and the punch 36 increases as shown in region P2.

As shown in region P3 of FIG. 7B, the gap 31b shown by FIG. 3A is not mashed easily when the valve 31 is closed. As shown by FIG. 7B, a gap 31c remains easily at two locations in the gap 31b having the quadrilateral configuration when the valve 31 is closed.

In the embodiment, the configuration of the major surface 31a of the valve 31 is set to be a semicircular configuration when viewed in cross-section; and the configuration of the gap 31b of the valve 31 is set to be a semicircular configuration when viewed in cross-section. In the valve system 30, the contact surface area between the valve 31 and the punch 36 is reduced when loading (when the flow channel of fluid is closed) by forming the valve 31 to be such a tube-type valve. The flow channel can be closed by a low load by reducing the contact surface area. The closure load of the punch 36 on the valve 31 can be decreased.

According to the embodiment, a high-performance and compact liquid feed device is provided.

### Second Embodiment

FIG. 8 is a schematic cross sectional view showing an enlarged valve in a valve system for a liquid feed device according to a second embodiment.

FIG. 8 is a cross sectional view of the valve 311 along a direction identical with the direction of the cross section shown in FIG. 2B. The major surface 311a of the valve 311 has a semicircular configuration when viewed in cross-section. The configuration of the major surface (the outer edge portion) 31a when projected onto the plane perpendicular to the direction of the flow channel of fluid is a protruding configuration having a curved surface of a semicircular configuration, and the configuration of the major surface 31a is symmetric with respect to the direction of the flow channel. The gap 311b of the valve 311 has a triangular configuration when viewed in cross-section. The gap 311b has a triangular configuration when projected onto the plane perpendicular to the direction of the flow channel.

In the valve system of FIG. 8, the closure load of the punch 36 on the valve 311 is reduced by forming the valve 311 to be such a tube-type valve as described above.

Analysis results used as the basis for discovering the configuration of the valve 311 such as those recited above will now be described.

### Third Analysis

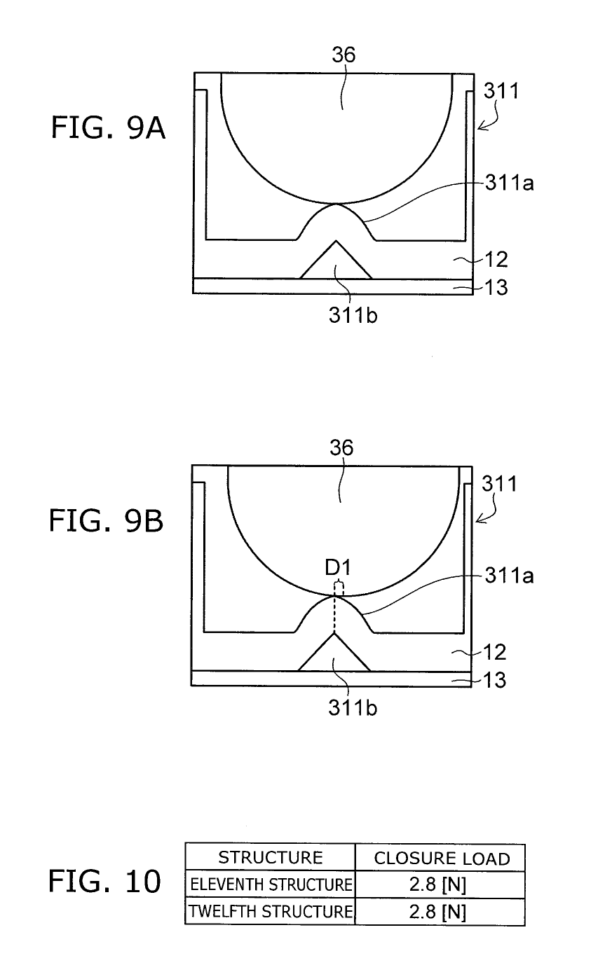

FIG. 9A and FIG. 9B are schematic cross sectional views showing the state that the valve contacts the punch according to the second embodiment.

FIG. 10 is a table showing a relationship between the structures of the valves and the closure loads.

FIG. 9A and FIG. 9B are cross-sectional views of the valve 311 along a direction identical with the direction of the cross section of the valve 31 such as that shown in FIG. 2B. FIG. 10 shows the closure load (N) of the punch 36 applied to each valve at the states of FIG. 9A and FIG. 9B.

In the following analysis, in FIG. 9A, the configuration of the major surface 311a of the valve 311 is set to be a semicircular configuration when viewed in cross-section; and the configuration of the gap 311b of the valve 311 is set to be a triangular configuration when viewed in cross-section. In the drawing, the dotted line indicates that the center of the punch 36 matches the center of the gap 311b. The structure of FIG. 9A is referred to as an eleventh structure.

In FIG. 9B, the configuration of the major surface 311a of the valve 311 is set to be a semicircular configuration when viewed in cross-section; and the configuration of the gap 311b of the valve 311 is set to be a triangular configuration when viewed in cross-section. In the drawing, the dotted line indicates that the center of the punch 36 is shifted D1 to the right from the center of the gap 311b. In the analysis, D1 is 0.1 millimeters. The structure of FIG. 9B is referred to as a twelfth structure.

As shown in FIG. 10, the closure loads of the eleventh structure and the twelfth structure are small. It was found that the tube-type valve of the embodiment is effective for reducing the closure load.

### Fourth Analysis

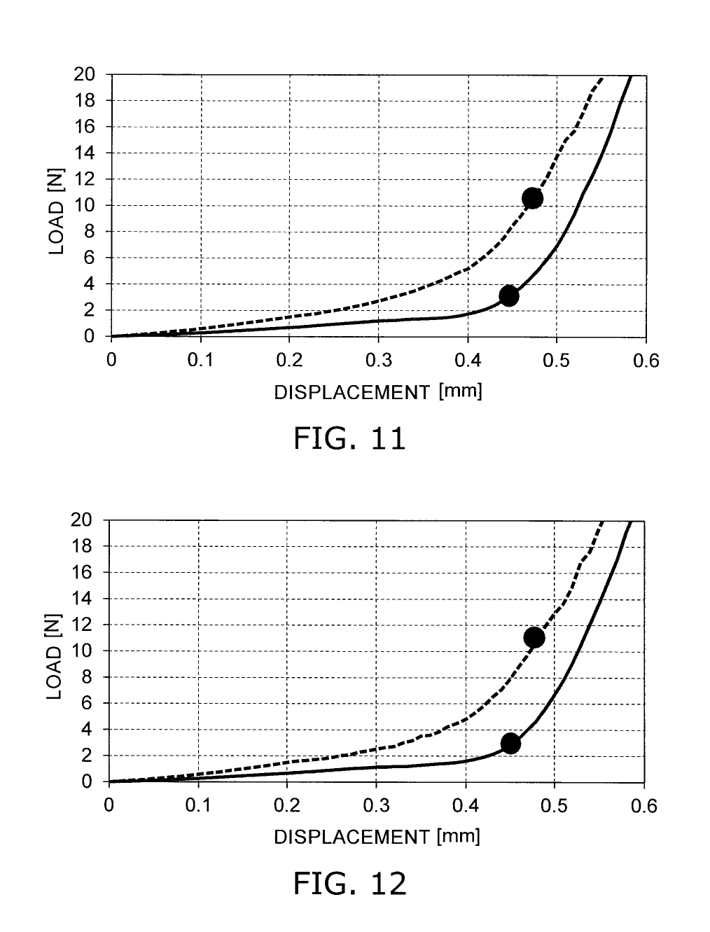

FIG. 11 shows a graph showing a relationship between the load inside the valve system and the displacement of the valve.

In FIG. 11, the vertical axis is the load (N). The horizontal axis is the displacement (millimeters) of the valve 31 in the drive direction of the punch 36.

In FIG. 11, the solid line shows a relationship between the load inside the valve system and the displacement of the valve in the case where the eleventh structure of FIG. 9A is applied. More specifically, the solid line shows the case where the configuration of the major surface 311a of the valve 311 is set to be a semicircular configuration when viewed in cross-section, the configuration of the gap 311b of the valve 311 is set to be a triangular configuration when viewed in cross-section, and the center of the punch 36 is set to match the center of the gap 311b.

The dotted line shows a relationship between the load inside the valve system and the displacement of the valve in the case where the fifth structure of FIG. 3E is applied. More specifically, the dotted line shows the case where the configuration of the major surface 31a of the valve 31 is set to be a semicircular configuration when viewed in cross-section, the configuration of the gap 31b of the valve 31 is set to be a semicircular configuration when viewed in cross-section, and the center of the punch 36 is set to match the center of the gap 31b.

In the eleventh structure, the displacement of the valve 311 is 0.44 millimeters and the closure load is 2.8 (N) when the valve 311 is closed. In the fifth structure, the displacement of the valve 31 is 0.47 millimeters and the closure load is 10.1 (N) when the valve 31 is closed.

The closure load of the eleventh structure is small. In the eleventh structure, the displacement of the valve 311 is small when the valve 311 is closed. It was found that the tube-type valve of the embodiment is effective for reducing the closure load.

### Fifth Analysis

FIG. 12 shows a graph showing a relationship between the load inside the valve system and the displacement of the valve.

In FIG. 12, the vertical axis is the load (N). The horizontal axis is the displacement (millimeters) of the valve 31 in the drive direction of the punch 36.

In FIG. 12, the solid line shows a relationship between the load inside the valve system and the displacement of the valve for the twelfth structure of FIG. 9B. More specifically, the solid line shows the case where the configuration of the major surface 311a of the valve 311 is set to be a semicircular configuration when viewed in cross-section, the configuration of the gap 311b of the valve 311 is set to be a triangular configuration when viewed in cross-section, and the center of the punch 36 is set to be shifted D1 to the right from the center of the gap 311b.

The dotted line shows a relationship between the load inside the valve system and the displacement of the valve for the tenth structure of FIG. 5E. More specifically, the dotted line shows the case where the configuration of the major surface 31a of the valve 31 is set to be a semicircular configuration when viewed in cross-section, the configuration of the gap 31b of the valve 31 is set to be a semicircular configuration when viewed in cross-section, and the center of the punch 36 is set to be shifted D1 to the right from the center of the gap 31b.

In the twelfth structure, the displacement of the valve 311 is 0.45 millimeters and the closure load is 2.8 (N) when the valve 311 is closed. In the tenth structure, the displacement of the valve is 0.48 millimeters and the closure load is 10.7 (N) when the valve 311 is closed.

The closure load of the twelfth structure is small. In the twelfth structure, the displacement of the valve 311 is small when the valve 311 is closed. In the case where the center of the punch 36 is shifted D1 to the right from the center of the gap 31b, the effects on the closure load (N) of the punch 36 are small. It was found that the tube-type valve of the embodiment is effective for reducing the closure load.

In the embodiment, the configuration of the major surface 311a of the valve 311 is set to be a semicircular configuration when viewed in cross-section; and the configuration of the gap 311b of the valve 311 is set to be a triangular configuration when viewed in cross-section. In the valve system of the embodiment, the contact surface area between the valve 311 and the punch 36 when loading (when the flow channel is closed) is reduced by forming the valve 311 to be such a tube-type valve. In the valve system of the embodiment, the flow channel can be closed by a low load by reducing the contact surface area. The closure load of the punch 36 on the valve 311 decreases.

In the embodiment, the gap 311b of the valve 311 has a triangular configuration when viewed in cross-section. The gap 311b may have a polygonal configuration, for example, a pentagonal configuration. By setting the configuration of the gap 311b to be a pentagonal configuration, the accumulation of bubbles at the end portion of the gap 311b when feeding the reagent can be suppressed.

According to the embodiment, a high-performance and compact liquid feed device is provided.

Hereinabove, embodiments of the invention are described with reference to specific examples. However, the invention is not limited to these specific examples. For example, one skilled in the art may similarly practice the invention by appropriately selecting specific configurations of components included in the liquid feed device such as the upper plate, the packing, the lower plate, the syringe, the valve, etc., and specific configurations of components included in the valve system such as the input port, the output port, the micro flow channel, the pressure control port, the punch, the pressure controller, etc., from known art; and such practice is within the scope of the invention to the extent that similar effects can be obtained.

Moreover, combinations of two or more components within a technically feasible range are also included in the scope of the invention as long as the spirit of the invention is included.

In addition, any liquid feed device and valve system, which those skilled in the art can carry out by making appropriate design modifications based on the liquid feed device and the valve system described above as the embodiments of the invention, are also in the scope of the invention as long as the spirit of the invention is included.

Also, within the scope of principles of the invention, various changes and modifications will be readily made by those skilled in the art. Accordingly, it will be appreciated that such changes and modifications also fall within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A liquid feed device, comprising:
a support substrate; and
an intermediate member provided on the support substrate, a valve and a flow channel of fluid being formed by the intermediate member, the valve communicating with the flow channel, the valve including an outer edge portion and a gap, the gap being provided between the outer edge portion and the support substrate, the valve being capable of opening and closing the gap by the outer edge portion being pressed and released,
a configuration of the outer edge portion when projected onto a plane perpendicular to a direction of the flow channel being a protruding configuration having a curved surface, the configuration of the outer edge portion being symmetric with respect to the direction of the flow channel.

2. The device according to claim 1, wherein the configuration of the outer edge portion when projected onto the plane perpendicular to the direction of the flow channel has line symmetry with respect to a straight line passing through a center of the gap.

3. The device according to claim 1, wherein the configuration of the outer edge portion when projected onto the plane perpendicular to the direction of the flow channel is a semicircular configuration.

4. The device according to claim 1, wherein the gap has a semicircular configuration when projected onto the plane perpendicular to the direction of the flow channel.

5. The device according to claim 1, wherein the gap has a polygonal configuration when projected onto the plane perpendicular to the direction of the flow channel.

6. The device according to claim 5, wherein the gap has a triangular configuration when projected onto the plane perpendicular to the direction of the flow channel.

7. The device according to claim 1, wherein the valve has a circular configuration when projected onto a plane perpendicular to a direction from the support substrate toward the intermediate member.

8. The device according to claim 7, wherein the valve has an elliptical configuration when projected onto the plane perpendicular to the direction from the support substrate toward the intermediate member.

9. The device according to claim 1, wherein the intermediate member is an elastic body.

10. The device according to claim 9, wherein the elastic body has a loss coefficient of 0.1 or less.

11. A liquid feed device, comprising:
a support substrate; and
an intermediate member provided to have a gap interposed between the support substrate and the intermediate member, the gap passing and blocking a fluid, the intermediate member opening and closing the gap by an outer edge of the intermediate member being pressed,
a configuration of the outer edge when projected onto a plane parallel to a direction from the support substrate toward the intermediate member being a protruding configuration having a curved surface and line symmetry with respect to a straight line passing through a center of the gap.

12. A valve system, comprising:
a liquid feed part including a support substrate and an intermediate member provided on the support substrate, the intermediate member including a valve and a flow channel communicating with the valve, the valve opening and closing a gap by an outer edge portion of the valve being pressed; and
a pressing body pressing the outer edge portion,
a configuration of the outer edge portion when projected onto a plane perpendicular to a direction of the flow channel being a protruding configuration having a curved surface, the configuration of the outer edge portion being symmetric with respect to the direction of the flow channel.

13. The system according to claim 12, wherein the configuration of the outer edge portion when projected onto the plane perpendicular to the direction of the flow channel has line symmetry with respect to a straight line passing through a center of the gap

14. The system according to claim 12, wherein the configuration of the outer edge portion when projected onto the plane perpendicular to the direction of the flow channel is a semicircular configuration.

15. The system according to claim 12, wherein the gap has a semicircular configuration when projected onto the plane perpendicular to the direction of the flow channel.

16. The system according to claim 12, wherein the gap has a polygonal configuration when projected onto the plane perpendicular to the direction of the flow channel.

17. The system according to claim 12, wherein the valve has a circular configuration when projected onto a plane perpendicular to a direction from the support substrate toward the intermediate member.

18. The system according to claim 17, wherein the valve has an elliptical configuration when projected onto the plane perpendicular to the direction from the support substrate toward the intermediate member.

19. The system according to claim 12, wherein the intermediate member is an elastic body.

20. The system according to claim 19, wherein the elastic body has a loss coefficient of 0.1 or less.
